(19) United States
(12) Patent Application Publication
(10) Pub. No.: US 2006/0248005 A1
(43) Pub. Date: Nov. 2, 2006

(54) Techniques for protecting financial transactions

(76) Inventor: Barbara A. Moore, Gainesville, VA (US)

Correspondence Address: FISH & RICHARDSON P.C., P.O. BOX 1022, MINNEAPOLIS, MN, 55440-1022, US

(21) Appl. No.: 10/423,012

(22) Filed: Apr. 25, 2003

(51) Int. Cl. G06Q 40/00

(52) U.S. Cl. 705/39

(57) ABSTRACT

Enhanced security is provided for a transaction involving a customer using a financial device associated with a financial account. Information regarding an authorized user of the financial account is received and stored in a storage system prior to the transaction. The information is capable of being used by a person to identify the authorized user. The stored information is provided to a merchant such that the information can be used by a person to determine whether or not the customer and the authorized user are the same before the transaction is completed. If the customer and the authorized user are determined to be the same, then the transaction is completed.

### TECHNICAL FIELD

This description relates to security for financial transactions.

### BACKGROUND

Credit card theft costs consumers and retailers millions of dollars every year and has ruined the credit records of numerous innocent victims. A traditional method of combating credit card theft uses a signature field placed on the back of the card in which the authorized user is to sign his or her name. Merchants are then supposed to verify that the signature on the receipt matches the signature on the back of the card. A criminal, however, may forge a signature, or put a piece of tape over the owner's signature on the credit card and sign it in the criminal's handwriting. In this case, the handwriting will match the receipt because the criminal signed both of them.

In further attempts to prevent credit card theft, some card companies provide a card that includes the authorized user's photograph. Criminals, however, are able to counterfeit such a credit card by copying a genuine account number onto magnetic strips of a counterfeit credit card that includes the criminal's photograph.

Many retailers subject consumers to further vulnerability by allowing customers to swipe their own cards through card readers without bothering to look at the name on the card or ask for identification. Some retailers may be reluctant to ask for identification because some customers become angry and hostile when asked to show identification, even in cases where the authorized user has written “See I.D.” in the signature field on the card. Even when retailers do ask to see a photo identification card, this type of card is commonly counterfeited and can be obtained easily.

### SUMMARY

Enhanced security is provided for a transaction involving a customer using financial device associated with a financial account. Information regarding an authorized user of the financial account is received and stored in a storage system prior to the transaction. The information is capable of being used by a person to identify the authorized user. The stored information is provided to a merchant such that the information can be used by a person to determine whether the customer and the authorized user are the same before the transaction is completed.

To conduct the transaction, the information regarding the authorized user is received from the storage system. The receiver of the information uses the information to determine, before the transaction is completed, whether or not the customer and the authorized user are the same. If the customer and the authorized user are determined to be the same person, then the transaction is completed.

A system including the storage system and a display device may be used to provide the enhanced security. The storage system contains the information regarding the authorized user. The display device presents the stored information such that a person can use the information to determine whether the customer and the authorized user are the same before the transaction is completed.

Implementations may include one or more of the following features. For example, the information may include a photograph of the authorized user, a signature of the authorized user, height information of the authorized user, an audio recording of the authorized user's voice, and/or any other information that would allow a person to identify the authorized user. Also, a number of different actions may be taken when a determination is made that the customer and the authorized user are not the same. For example, a store manager may be notified, the transaction may be declined, further proof of identification may be required from the customer, a law enforcement officer may be contacted, or other established protocols may be followed.

The financial device may be a credit or debit card and the system also may include a credit or debit card reader that is configured to read account information from the credit or debit card. The financial device also may be a check.

The system may include a pager that is configured to notify a store manager when a determination is made that the customer and the authorized user are not the same. In addition, a signature capture device may be used to capture the customer's signature, and the signature of the customer may be displayed on the display device along with the signature of the authorized user.

The transaction may be conducted using a client system connected to a network. A camera may be connected to the client system. To conduct the transaction, the customer may use the client system and camera to transmit information regarding the financial device and a photograph of the customer across the network to a merchant. A signature capture device also may be connected to the client system to transmit a signature of the customer to the merchant.

Implementations of the described techniques may deter the use of stolen cards, stolen card numbers, and fraud or other illegal use of financial devices in general, and may lead to the apprehension of those who attempt to engage in such conduct. Implementations may do so at a lower cost than other solutions such as biometric scanners.

Implementations of the described techniques may include hardware, a method or process, or computer software on a computer-accessible medium.

The details of one or more implementations are set forth in the accompanying drawings and the description below. Other features will be apparent from the description and drawings, and from the claims.

### DESCRIPTION OF DRAWINGS

FIG. 1 is a block diagram of a system that may be used to conduct credit or debit card transactions with enhanced security.

FIGS. 2A and 2B are flowcharts illustrating a method of providing enhanced security for credit or debit card transactions.

FIG. 3 is an illustration showing an exemplary display of authorized user information that may be presented on a display device.

FIG. 4 is a block diagram of a system that may be used to conduct credit or debit card transactions over a network such as the Internet with enhanced security.

### DETAILED DESCRIPTION

In one general aspect, extra security against credit or debit card theft is provided through the storage (for example, in a database) of information about the authorized user that is capable of being used by a person to identify the authorized user (such as a photograph of the authorized user, the signature of the an audio recording of the authorized user's voice the height of the authorized user, and/or any other information that would allow a person to identify the authorized user). When an attempt is made to use the authorized user's credit or debit card, the information is presented to a person so that the person can verify that the person using the credit or debit card is the authorized user.

While the present techniques are primarily described in relation to credit or debit cards, these techniques may be used with any financial device that may be used by a customer to effectuate a transaction. For example, a MICR check reader may be used in conjunction with the described techniques to provide enhanced security for checks. As used herein, a financial device is any item that bears information regarding a financial account and that may be used to effectuate a financial transaction involving that account. Examples of financial devices include credit cards, debit cards, personal checks, and traveler's checks.

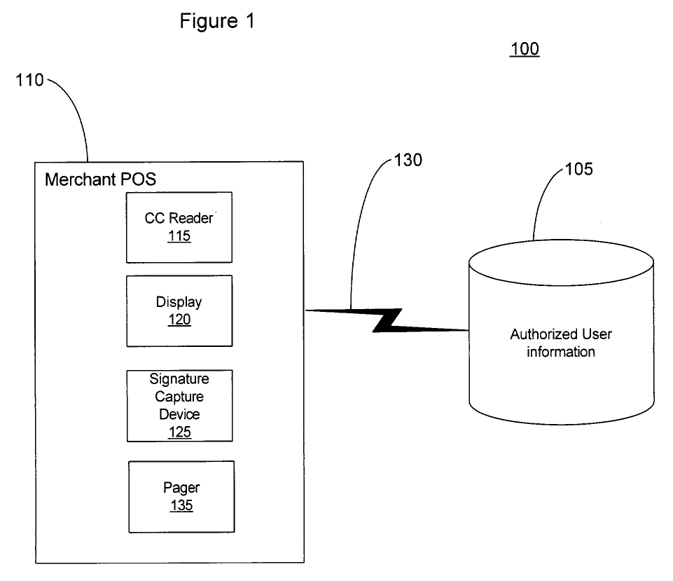

FIG. 1 shows a block diagram of a system that may be used for conducting transactions with enhanced security. The system 100 includes an authorized user information storage system 105 in communication with a merchant point of sale (POS) device 110.

Storage system 105 stores information regarding authorized users that can be used by a person to identify the authorized users visually. Such information may include, for example, a photograph of an authorized user, a copy of the authorized user's signature and/or the height of the authorized user. The storage system 105 may be, for example, a database. Storage system 105 may be maintained by the merchant, the company or bank issuing the credit or debit card, or a third-party vendor. Storage system 105 may be located at the merchant's store, at the location of the company or bank that issued the card, or at a third-party vendor's location.

POS device 110 may be located at the merchant's store or at any other location at which the merchant wishes to conduct sales transactions. A retail clerk or other store employee may use POS device 110 (and perform the other actions described as being performed by the merchant) on behalf of the merchant to complete sales transactions and other store business.

The POS device 110 may include a credit card reader 115 for conducting a credit or debit card transaction and a visual display device 120 for visually displaying the authorized user information that can be used by a person to visually identify the authorized user. The display device 120 also may display other information, such as information related to the credit or debit card transaction, including, for example, the amount of the transaction. The display device 120 may be positioned such that the display device 120 can be seen by the user of the POS device (such as a merchant or retail clerk), but not the customer. A signature capture device 125 may be included so as to capture a customer's signature electronically for the sales draft. Further, when the signature of the authorized user is stored in storage system 105, the electronically captured signature may be displayed on display device 120 along with the previously stored signature of the authorized user to provide for easier comparison between the two. POS device 110 also may include a pager 135 that may be used by a clerk to call or page management.

In addition, or alternatively, display device 120 may present the information to a person in manners other than visual, particularly if the information can be used to identify the authorized user in a non-visual. For example, if the information includes an audio recording of the authorized user's voice, the display device may comprise a speaker for outputting the recorded voice. In general, display device 120 may be any type of device that can present the information to a person.

Storage system 105 and POS device 110 are connected by a communication link 130. Communication link 130 may be a direct point-to-point link or may be a network of communications links (such as a packet or circuit switched network) connecting storage system 105 and POS device 110. Communication link 130 may be a credit card association's network. Examples of the communication link 130 may include the Internet, wide area networks (WANs), local area networks (LANs), analog or digital wired and wireless telephone networks (for example, a Public Switched Telephone Network [PSTN], an Integrated Services Digital Network [ISDN], or a Digital Subscriber Line [xDSL]), or any other wired or wireless communication link. The network 130 may include multiple networks or subnetworks, each of which may include, for example, a wired or wireless data pathway.

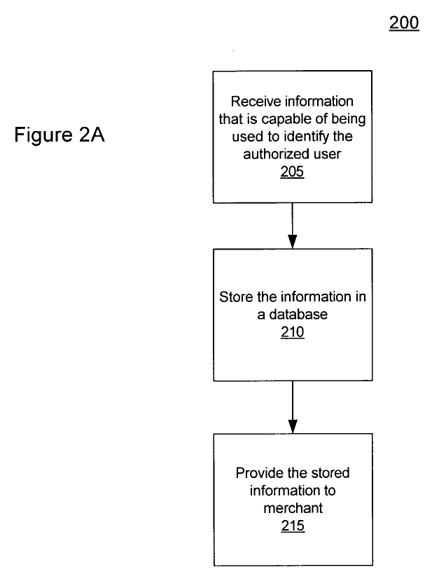

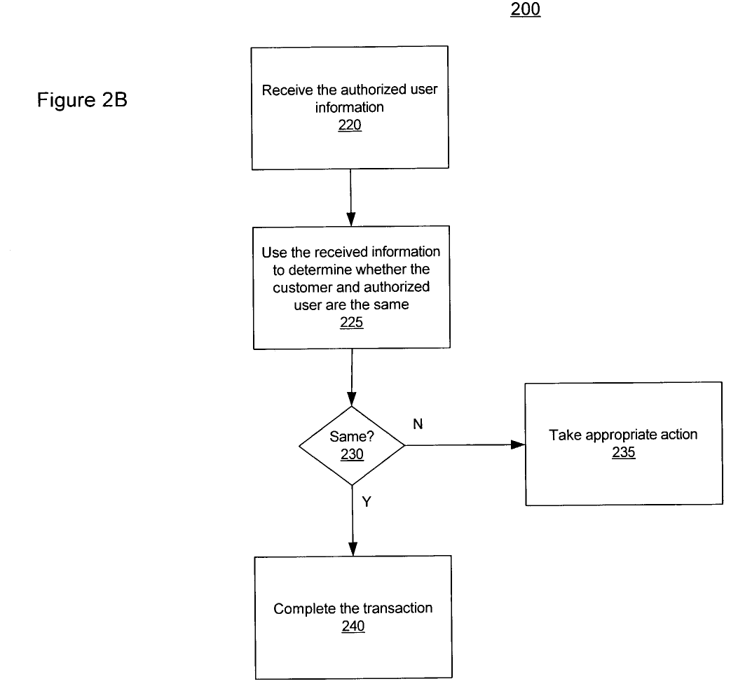

Referring to FIGS. 2A and 2B, a process 200 may be used to provide enhanced security for credit or debit card transactions. Referring to FIG. 2A, the maintainer of authorized user information storage system 105 receives (205) the information regarding the authorized user that can be used by a person to identify the authorized user. This information may be requested and received prior to the card being issued and, when a photograph and signature are stored, the card may be issued without a photograph or a signature space. When the information is received, the information is stored (210) along with the corresponding account number in the storage system 105.

Before a transaction involving the credit or debit card is completed, the information is provided to the merchant (215). The information may be provided in response to an electronic request for the information. The authorized user information may be requested at any point before or during the transaction. The request may be an explicit request, or the request may be implied, for example, in an initial request for authorization.

Referring to FIG. 2B, after the merchant receives the authorized user information (220), the merchant uses the information (225) to determine whether or not a customer attempting to use the credit or debit card and the authorized user are the same person. For example, if the authorized user information includes a photograph of the authorized user, the photograph may be displayed on display device 120 such that the merchant can compare the photograph with the face of the customer before finalizing the transaction. In this case, the display device 120 also may advise the merchant to “look beyond” features such as eyeglasses, hairstyle, hair color, and facial hair, as these may be modified by a criminal if he or she knows what the authorized user looks like. Likewise, authorized user height information may be displayed on display device 120 so that the merchant can compare the height of the customer with the authorized user's height. Also, for example, if a signature capture device 125 is present and the authorized user information includes the authorized user's signature, the captured signature and authorized user's signature may be displayed side by side on display device 120 for visual comparison.

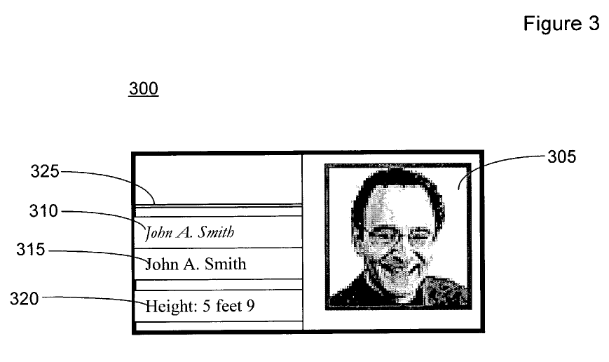

FIG. 3 illustrates an exemplary visual display 300 of authorized user information that may be presented on display device 120. The exemplary display 300 includes the authorized user's photograph 305 next to the authorized user's signature 310. Under the authorized user's signature 310, the authorized user's printed or typed name 315 is displayed. Authorized user height information 320 is displayed under the typed name 315. As the customer signs his or her name on the signature capture device 125, the captured signature's image (not shown) may appear on the double line 325. The merchant then may compare the captured signature with the authorized user's signature 310 and may compare the authorized user's photograph 305 with the customer's face to decide whether or not the customer is the authorized user.

Referring again to FIG. 2B, if the merchant has reason to believe that the customer presenting the card does not match the authorized user (230), then appropriate action may be taken such as requiring more proof of identification, or calling a law enforcement officer. If a retail clerk is conducting transactions on behalf of the merchant, the clerk may notify a manager using the pager 135. This may be done discretely, without the customer knowing, and the customer may be led to believe that “the system is slow” until the manager arrives to evaluate the situation. After evaluating the situation, the manager then may decide whether to complete the transaction, require more proof of identification, or call the authorities. The system 100 also may be designed to contact the credit card company's fraud department automatically if the manager asks for further proof of identification or declines to complete the transaction.

If a determination is made that the customer and authorized user are the same person, the transaction is completed (240) in accordance with normal processing procedures.

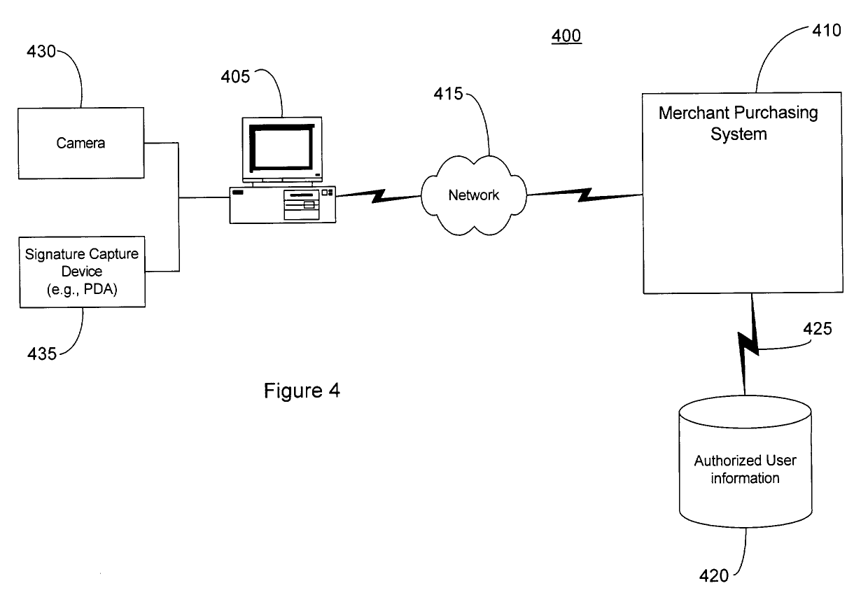

FIG. 4 illustrates a system 400 that may be used to conduct credit or debit card transactions over a network, such as the Internet, with enhanced security. As shown, a client system 405 is connected to a merchant purchasing system 410 through a network 415. Examples of the network 415 include the Internet, WANs, LANs, analog or digital wired and wireless telephone networks (for example a PSTN, an ISDN, or a xDSL), or any other wired or wireless network. The network 415 may include multiple networks or subnetworks, each of which may include, for example, a wired or wireless data pathway.

Client system 405 may be, for example, a general-purpose computer capable of responding to and executing instructions in a defined manner, a personal computer, a special-purpose computer, a workstation, a personal digital assistant, or other equipment capable of responding to and executing instructions. Client system 405 may receive instructions from, for example, a software application, a program, a piece of code, a device, a computer, a computer system, or a combination thereof, which independently or collectively direct operations.

Merchant purchasing system 410 may include, for example, a Web server running a Web site for receiving customer orders and otherwise conducting transactions with customers. The Web server may be running, for example, on a general-purpose computer capable of responding to and executing instructions in a defined manner, a personal computer, a special-purpose computer, a workstation, a personal digital assistant, or other equipment capable of responding to and executing instructions. Merchant purchasing system 410 may include other software or hardware components for processing customer transactions.

Merchant purchasing system 410 is connected to an authorized user information storage system 420 through a communication link 425. As with storage system 105, storage system 420 stores information regarding an authorized user that can be used by a person to identify the authorized user. Storage system 105 may be maintained by the merchant, the company or bank issuing the credit or debit card, or a third-party vendor. Communication link 425 may be similar to link 130. That is, link 425 may be a direct point-to-point link or may be network of communications links (for example, a packet or circuit switched network) connecting storage system 420 and merchant purchasing system 410, and may be a credit card association's network.

To conduct a credit or debit card transaction, a customer uses client system 405 to communicate with merchant purchasing system 410. For example, when merchant purchasing system 410 is running a Web site, a customer may use client system 405 to navigate to the Web site and enter transaction information, such as a credit or debit card number, to engage in a credit or debit card transaction with the merchant (for example, when purchasing goods or services from the merchant). In addition to communicating transaction information, the customer also transmits reliable information that allows the customer to be identified.

The transmitted identification information is comparable to the information stored in storage system 420. For example, if the authorized user's photograph is stored in storage system 420, a video capture device 430, such as a camera, may be connected to client system 405 and used to capture and transmit a real-time image of the customer as the customer is performing the transaction. If the authorized user's signature is stored in storage system 420, a signature capture device 435 (which may be a personal digital assistant, for example) may be connected to client system 405 and used to capture the customer's signature, which is then transmitted to merchant purchasing system 410. As an alternative, a scanner (not shown) may be connected to client system 405 and the customer's signature may be scanned for transmission to merchant purchasing system 410.

Before a credit or debit card transaction is completed, merchant purchasing system 410 receives authorized user information from storage system 420. The merchant uses the authorized user information and the information from the customer to determine whether or not the customer is the same person as the authorized user. If a determination is made that they are the same, then the transaction is completed.

A number of implementations have been described. Nevertheless, it will be understood that various modifications may be made. Accordingly, other implementations are within the scope of the following claims.

What is claimed is:

1. A method of conducting a transaction involving a customer using a financial device to effectuate the transaction, with the financial device being associated with a financial account, the method comprising:
receiving, from a storage system, information regarding an authorized user of the financial account, wherein the information is capable of being used by a person to identify the authorized user and was stored in the storage system prior to the transaction;
using the received information to determine, before the transaction is completed, whether or not the customer and the authorized user are the same, wherein a person uses the received information to make the determination; and
completing the transaction when the customer and authorized user are determined to be the same.

2. The method of claim 1 further comprising notifying a store manager when a determination is made that the customer and the authorized user are not the same.

3. The method of claim 1 further comprising declining to complete the transaction when a determination is made that the customer and the authorized user are not the same.

4. The method of claim 1 further comprising requiring further proof of identification from the customer when a determination is made that the customer and the authorized user are not the same.

5. The method of claim 1 further comprising contacting a law enforcement officer when a visual determination is made that the customer and the authorized user are not the same.

6. The method of claim 1 wherein the information comprises a photograph of the authorized user.

7. The method of claim 1 wherein the information comprises a signature of the authorized user.

8. The method of claim 1 wherein the information comprises height information of the authorized user.

9. The method of claim 1 wherein the financial device comprises a credit or a debit card.

10. The method of claim 1 wherein the financial device comprises a check.

11. A method of providing enhanced security for a transaction involving a customer using a financial device to effectuate the transaction, with the financial device being associated with a financial account, the method comprising:
receiving information regarding an authorized user of the financial account, wherein the information is capable of being used by a person to identify the authorized user;
storing the information in a storage system prior to the transaction; and
providing the stored information to a merchant such that the information can be used by a person to determine whether the customer and the authorized user are the same before the transaction is completed.

12. The method of claim 11 wherein the information comprises a photograph of the authorized user.

13. The method of claim 11 wherein the information comprises a signature of the authorized user.

14. The method of claim 11 wherein the information comprises height information of the authorized user.

15. The method of claim 111 wherein the financial device comprises a credit or debit card.

16. The method of claim 11 wherein the financial device comprises a check.

17. A system for use in a transaction involving a customer using a financial device to effectuate the transaction, with the financial device being associated with a financial account, the system comprising:
a storage system containing information regarding an authorized user of the financial account, wherein the information is capable of being used by a person to identify the authorized user and was stored in the storage system prior to the transaction; and
a display device to present the stored information to a person such that the person can use the information to determine whether the customer and the authorized user are the same before the transaction is completed.

18. The system of claim 17 wherein the financial device comprises a credit or debit card.

19. The system of claim 17 further comprising:
a credit card reader, configured to read account information from the credit or debit card; and
a pager configured to notify a store manager when a determination is made that the customer and the authorized user are not the same.

20. The system of claim 17 wherein the stored information comprises a photograph of the authorized user.

21. The system of claim 20 further comprising:
a client system connected to a network, wherein, to conduct the transaction, the customer uses the client system to transmit information regarding the financial device across the network to a merchant; and
a camera connected to the client system, wherein, to conduct the transaction, a photograph of the customer is taken with the camera and transmitted across the network to the merchant;
wherein the display device is located at the merchant such that the photograph of the customer and the photograph of the authorized user can be used by a person to visually determine whether the customer and the authorized user are the same before the transaction is completed.

22. The system of claim 21 wherein the stored information comprises a signature of the authorized user.

23. The system of claim 22 further comprising a signature capture device connected to the client system, wherein:
to conduct the transaction, a signature of the customer is recorded with the signature capture device and transmitted across the network to the merchant; and
the display device is located at the merchant such that the signature of the customer and the signature of the authorized user can be used by a person to determine whether the customer and the authorized user are the same before the transaction is completed.

24. The system of claim 23 wherein the signature capture device comprises a personal digital assistant.

25. The system of claim 17 wherein the stored information comprises a signature of the authorized user.

26. The system of claim 25 further comprising a signature capture device connected to the display device, wherein:
to conduct the transaction, a signature of the customer is recorded with the signature capture device; and
the signature of the customer is displayed on the display device with the signature of the authorized user so that the signature of the authorized user can be used by a person to determine whether the customer and the authorized user are the same before the transaction is completed.

27. The system of claim 25 further comprising a client system connected to a network, and a signature capture device connected to the client system, wherein:
to conduct the transaction, the customer uses the client system to transmit information regarding the financial device across the network to a merchant;
to conduct the transaction, a signature of the customer is recorded with the signature capture device and transmitted across the network to the merchant;
the device is located at the merchant such that the signature of the customer and the signature of the authorized user can be used by a person to determine whether or not the customer and the authorized user are the same before the transaction is completed.

28. The system of claim 17 wherein the stored information comprises height information of the authorized user.

29. The system of claim 17 wherein the financial device comprises a credit or debit card.

30. The system of claim 17 wherein the financial device comprises a check.
